(19) United States
(12) Patent Application Publication
(10) Pub. No.: US 2013/0162080 A1
(43) Pub. Date: Jun. 27, 2013

(54) HYDRODYNAMIC BEARING ASSEMBLY AND SPINDLE MOTOR INCLUDING THE SAME

(71) Applicant: Chang Jo YU, Suwon (KR)

(72) Inventor: Chang Jo YU, Suwon (KR)

(73) Assignee: SAMSUNG ELECTRO-MECHANICS CO., LTD., Suwon (KR)

(21) Appl. No.: 13/424,912

(22) Filed: Mar. 20, 2012

(30) Foreign Application Priority Data
Dec. 23, 2011 (KR) 10-2011-0141671

(51) Int. Cl. F16C 32/06; H02K 7/08

(52) U.S. Cl. 310/90; 384/114; 384/107; 384/118

(57) ABSTRACT

There are provided a hydrodynamic bearing assembly and a motor including the same. The hydrodynamic bearing assembly includes: a sleeve supporting a shaft and forming a bearing clearance filled with a lubricating fluid; a housing enclosing an outer peripheral surface of the sleeve and including a flange part formed in an upper end portion thereof and extended outwardly; a rotor hub coupled to an upper end portion of the shaft and including an extension wall part extended to be disposed outwardly of the housing; a stopper member fixed to the extension wall part while being disposed under the flange part of the housing, and forming, together with an outer peripheral surface of the housing, a space in which a liquid-vapor interface is formed; and a cover member coupled to a lower end portion of the housing. The sleeve and the housing include first and second circulation holes formed therebetween.

### CROSS-REFERENCE TO RELATED APPLICATIONS

This application claims the priority of Korean Patent Application No. 10-2011-0141671 filed on Dec. 23, 2011, in the Korean Intellectual Property Office, the disclosure of which is incorporated herein by reference.

### BACKGROUND OF THE INVENTION

1. Field of the Invention

The present invention relates to a hydrodynamic bearing assembly and a spindle motor including the same.

2. Description of the Related Art

A small spindle motor used in a hard disk drive (HDD) is generally provided with a hydrodynamic bearing assembly, and a bearing clearance between a shaft and a sleeve of the hydrodynamic bearing assembly is filled with lubricating fluid such as oil. The oil filling the bearing clearance generates hydrodynamic pressure while being compressed, thereby rotatably supporting the shaft.

That is, the hydrodynamic bearing assembly generally generates dynamic pressure through spiral shaped grooves in an axial direction and herringbone shaped grooves in a circumferential direction, thereby promoting stability of rotational driving of the spindle motor.

Meanwhile, in accordance with an increase in capacity of the hard disk drive, it is necessary to reduce vibrations generated during the driving of the spindle motor. That is, in order to allow the hard disk drive to be driven without an error due to the vibrations generated during the driving of the spindle motor, the demand for improvement in performance of the hydrodynamic bearing assembly provided in the spindle motor has increased.

In order to improve the performance of the hydrodynamic bearing assembly, there is a need to increase an interval (that is, bearing span length) between the herringbone shaped grooves to move the center of rotation upwardly, thereby promoting stability of the driving of the spindle motor.

In addition, the spindle motor has been used in a portable electronic device, such that the demand for reduction in power consumption has increased.

The development of a structure capable of reducing power consumption while promoting stability of driving of a motor as described above has been urgently demanded.

In Related Art Documents described below, Related Art Document 1 fails to disclose that two circulations of a fluid are formed, and Related Art Document 2 discloses a spindle motor in which a housing is not provided.

### Related Art Document

(Patent Document 1) Japanese Patent Laid-open Publication No. 2006-022831

(Patent Document 2) Japanese Patent Laid-open Publication No. 2004-270820

### SUMMARY OF THE INVENTION

An aspect of the present invention provides a hydrodynamic bearing assembly capable of preventing generation of negative pressure and excessive floating of a rotor and easily discharging air bubbles, and a spindle motor including the same.

According to an aspect of the present invention, there is provided a hydrodynamic bearing assembly including: a sleeve supporting a shaft such that an upper end portion of the shaft is protruded upwardly in an axial direction, and forming a bearing clearance filled with a lubricating fluid; a housing provided to enclose an outer peripheral surface of the sleeve and including a flange part formed in an upper end portion thereof and extended outwardly; a rotor hub coupled to the upper end portion of the shaft and including an extension wall part extended to be disposed outwardly of the housing; a stopper member fixed to the extension wall part of the rotor hub while being disposed under the flange part of the housing, and forming, together with an outer peripheral surface of the housing, a space in which a liquid-vapor interface is formed; and a cover member coupled to a lower end portion of the housing, wherein the sleeve and the housing include a first circulation hole formed therebetween in order to connect upper and lower portions of the sleeve to each other, and a second circulation hole formed therebetween in order to connect the first circulation hole and a space formed by the stopper member and the outer peripheral surface of the housing to each other.

The sleeve and an inner surface of a portion of the housing in which the flange part is provided may form an annular space therebetween.

A first thrust dynamic pressure generating groove for generating thrust hydrodynamic pressure may be formed in at least one of a lower surface of the shaft and an upper surface of the cover member.

A second thrust dynamic pressure generating groove for generating thrust hydrodynamic pressure may be formed in at least one of a lower surface of the flange part and an upper surface of the stopper member.

At the time of rotational driving of the shaft, a first circulation in which the lubricating fluid moves from a lower portion of the first circulation hole toward an upper portion thereof and a second circulation in which the lubricating fluid moves from the first circulation hole toward a bearing clearance formed by the flange part and the stopper member may be formed.

The shaft may include upper and lower radial dynamic pressure generating grooves formed in an outer peripheral surface thereof in order to generate hydrodynamic pressure at the time of rotational driving thereof, and the lubricating fluid may move from the upper radial dynamic pressure generating groove toward the lower radial dynamic pressure generating groove.

The housing may be integrally provided with the cover member.

The shaft may be integrally provided with the rotor hub.

The first circulation hole may be provided as a communication groove formed in at least one of the outer peripheral surface of the sleeve and an inner peripheral surface of the housing.

According to another aspect of the present invention, there is provided a hydrodynamic bearing assembly including: a sleeve supporting a shaft such that an upper end portion of the shaft is protruded upwardly in an axial direction, forming a bearing clearance filled with a lubricating fluid, and including a flange part formed in an upper end portion thereof and extended outwardly; a housing provided to enclose an outer peripheral surface of the sleeve while allowing an upper end surface thereof to be spaced apart from a lower surface of the flange part of the sleeve by a predetermined interval; a rotor hub coupled to the upper end portion of the shaft and including an extension wall part extended to be disposed outwardly of the sleeve and the housing; a stopper member fixed to the extension wall part of the rotor hub while being disposed under the flange part of the sleeve and forming, together with an outer peripheral surface of the housing, a space in which a liquid-vapor interface is formed; and a cover member coupled to a lower end portion of the housing, wherein the sleeve and the housing includes a third circulation hole formed therebetween in order to connect a lower portion of the sleeve and the upper end surface of the housing to each other and a fourth circulation hole formed therebetween in order to connect the third circulation hole and an upper portion of the sleeve to each other.

A third thrust dynamic pressure generating groove for generating thrust hydrodynamic pressure may be formed in at least one of a lower surface of the shaft and an upper surface of the cover member.

A fourth thrust dynamic pressure generating groove for generating thrust hydrodynamic pressure may be formed in at least one of a lower surface of the flange part and an upper surface of the stopper member.

At the time of rotational driving of the shaft, a third circulation in which the lubricating fluid moves from lower portions of the third and fourth circulation holes toward upper portions thereof and a fourth circulation in which the lubricating fluid moves from the third circulation hole toward a bearing clearance formed by the flange part and the stopper member may be formed.

The shaft may include upper and lower radial dynamic pressure generating grooves formed in an outer peripheral surface thereof in order to generate hydrodynamic pressure at the time of rotational driving thereof, and the lubricating fluid may move from the upper radial dynamic pressure generating groove toward the lower radial dynamic pressure generating groove.

The third circulation hole may be provided as a communication groove formed in at least one of the outer peripheral surface of the sleeve and an inner peripheral surface of the housing.

The fourth circulation hole may penetrate through the flange part so as to connect the third circulation hole and the upper portion of the sleeve to each other.

According to another aspect of the present invention, there is provided a spindle motor including: the hydrodynamic bearing assembly as described above; and a stator coupled to an outside of the housing and including a core having a coil wound therearound in order to generate rotational driving force.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic cross-sectional view showing a spindle motor according to an embodiment of the present invention;

FIGS. 2A and 2B are perspective views showing a sleeve according to an embodiment of the present invention;

FIG. 3 is a view describing an operation of a spindle motor according to an embodiment of the present invention;

FIG. 4 is a cross-sectional view schematically showing a spindle motor according to another embodiment of the present invention;

FIGS. 5A and 5B are perspective views showing a sleeve according to another embodiment of the present invention; and

FIG. 6 is a view describing an operation of a spindle motor according another embodiment of the present invention.

### DETAILED DESCRIPTION OF THE INVENTION

Embodiments of the present invention will now be described in detail with reference to the accompanying drawings. However, it should be noted that the spirit of the present invention is not limited to the embodiments set forth herein and those skilled in the art and understanding the present invention can easily accomplish retrogressive inventions or other embodiments included in the spirit of the present invention by the addition, modification, and removal of components within the same spirit, but those are construed as being included in the spirit of the present invention.

Further, when it is determined that the detailed description of the known art related to the present invention may obscure the gist of the present invention, the detailed description thereof will be omitted.

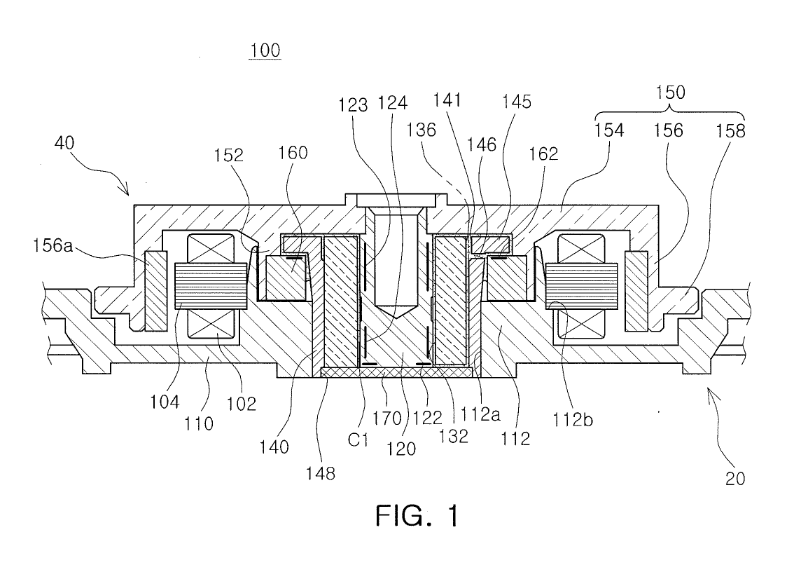

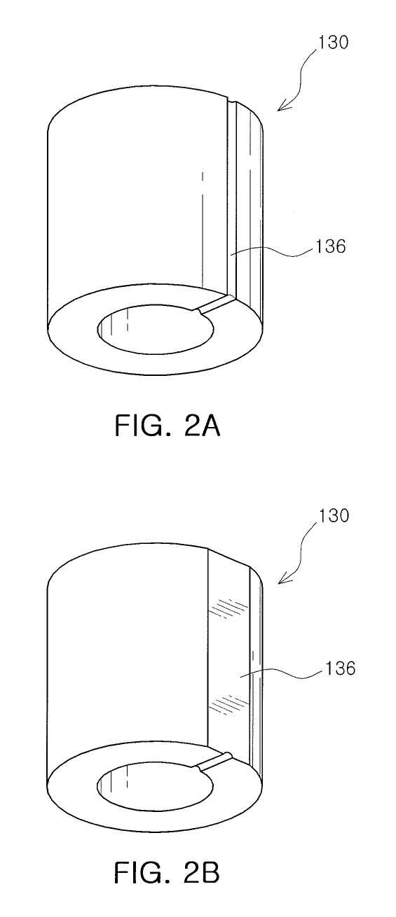

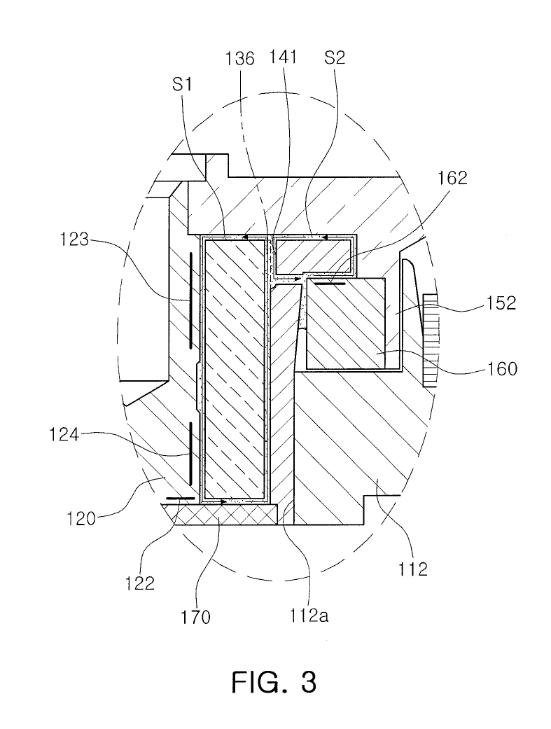

FIG. 1 is a schematic cross-sectional view showing a spindle motor according to an embodiment of the present invention; FIGS. 2A and 2B are perspective views showing a sleeve according to the embodiment of the present invention; and FIG. 3 is a view describing an operation of the spindle motor according to the embodiment of the present invention.

Referring to FIGS. 1 through 3, a spindle motor 100 according to this embodiment of the present invention may include a base member 110, a shaft 120, a sleeve 130, a housing 140, a rotor hub 150, a stopper member 160, and a cover member 170.

The spindle motor 100 may be a motor used in a hard disk drive driving a recoding disk.

Here, terms with respect to directions will be defined. As viewed in FIG. 1, an axial direction refers to a vertical direction, that is, a direction from a lower portion of the shaft 120 toward an upper portion thereof or a direction from the upper portion of the shaft 120 toward the lower portion thereof, and a radial direction refers to a horizontal direction, that is, a direction from an outer peripheral surface of the rotor hub 150 toward the shaft 120 or from the shaft 120 toward the outer peripheral surface of the rotor hub 150.

In addition, a circumferential direction refers to a rotation direction along an outer peripheral surface of the rotor hub 150 or the shaft 120.

Further, a hydrodynamic bearing assembly according to the embodiment of the present invention may include members related to a principle of a bearing utilizing dynamic pressure of a fluid, that is, members other than the base member 110. That is, the hydrodynamic bearing assembly may include the shaft 120, the sleeve 130, the housing 140, the rotor hub 150, the stopper member 160, and the cover member 170.

The base member 110, which is a fixed member, may form a stator 20. Here, the stator 20, referring to all fixed members except for rotating members, may include the base member 110, the sleeve 130, the housing 140, and the like.

In addition, the base member 110 may include an installation part 112 having the housing 140 insertedly installed therein. The installation part 112 may be protruded upwardly in the axial direction and include an installation hole 112a formed therein so that the housing 140 may be insertedly installed therein.

In addition, the installation part 112 may include a seat surface 112b formed on an outer peripheral surface thereof so that a stator core 104 having a coil 102 wound therearound may be seated thereon. That is, the stator core 104 may be fixed to the outer peripheral surface of the installation part 112 by an adhesive in a state in which it is seated on the seat surface 112b.

However, the stator core 104 may also be installed on the outer peripheral surface of the installation part 112 in a press-fitting scheme without using the adhesive. That is, a scheme of installing the stator core 104 is not limited to the use of the adhesive.

The shaft 120, which is a rotating member, may form a rotor 40. Here, the rotor 40 refers to a member rotatably supported by the stator 20 to thereby rotate.

Meanwhile, the shaft 120 may be rotatably supported by the sleeve 130. In addition, as shown in FIG. 1, the shaft 120 may include a first thrust dynamic pressure generating groove 122 formed in a lower surface thereof in order to generate thrust hydrodynamic pressure at the time of rotation thereof.

Meanwhile, the first thrust dynamic pressure generating groove 122 is not limited to being formed in the lower surface of the shaft 120, but may also be formed in an upper surface of the cover member 170 disposed to face the lower surface of the shaft 120.

As described above, the first thrust dynamic pressure generating groove 122 is formed in the lower surface of the shaft 120 or the upper surface of the cover member 170 disposed to face the lower surface of the shaft 120, such that a length of the first thrust dynamic pressure generating groove 122 in the radial direction is reduced, whereby power consumption may be further reduced.

Meanwhile, the first thrust dynamic pressure generating groove 122 may have a herringbone shape or a spiral shape. However, the first dynamic pressure generating groove 122 is not limited to having the above-mentioned shape, but may have any shape as long as it can generate hydrodynamic pressure at the time of the rotation of the shaft 120.

Meanwhile, the shaft 120 may include upper and lower radial dynamic pressure generating grooves 123 and 124 formed in an outer peripheral surface thereof in order to generate hydrodynamic pressure at the time of rotational driving thereof. In addition, the upper and lower radial dynamic pressure generating grooves 123 and 124 may be disposed to be spaced apart from each other by a predetermined interval and have a herringbone or spiral shape.

In addition, at the time of the rotational driving of the shaft 120, a lubricating fluid may move from the upper radial dynamic pressure generating groove 123 toward the lower radial dynamic pressure generating groove 124. That is, the spindle motor 100 according to the present embodiment may have a down pumping structure.

The sleeve 130, which is a fixed member forming the stator 20 together with the housing 140 and the base member 110, may rotatably support the shaft 120 and form a bearing clearance C1 filled with the lubricating fluid. The sleeve 130 may be formed by sintering a Cu—Fe-based alloy powder or a SUS-based powder.

Meanwhile, the sleeve 130 may be inserted into the installation part 112 of the base member 110 in a state in which it is fixed in the housing 140, such that it may be fixedly installed indirectly to the base member 110. That is, an outer peripheral surface of the housing 140 may be adhered to an inner peripheral surface of the installation part 112 by an adhesive.

Further, the sleeve 130 may include a shaft hole 132 formed therein, such that the shaft 120 is inserted thereinto. Further, in the case in which the shaft 120 is insertedly disposed in the shaft hole 132 of the sleeve 130, an inner peripheral surface of the sleeve 130 and the outer peripheral surface of the shaft 120 may be spaced apart from each other by a predetermined interval to thereby form the bearing clearance C1 therebetween.

Here, the bearing clearance C1 will be described in more detail. As described above, the sleeve 130 forms the bearing clearance C1 filled with the lubricating fluid. This bearing clearance C1 indicates a clearance formed by the shaft 120 and the sleeve 130, a clearance formed by an upper end portion of the sleeve 130 and the rotor hub 150, a clearance formed by a flange part 145 of the housing 140 and the rotor hub 150, a clearance formed by the housing 140 and the stopper member 160, and a clearance formed by the cover member 170 and the lower surface of the shaft 120.

In addition, the spindle motor 100 according to the present embodiment may have a structure in which the entire bearing clearance C1 is filled with the lubricating fluid. This structure may be called a full-fill structure.

Meanwhile, the sleeve 130 may include upper and lower radial dynamic pressure generating grooves formed in the inner peripheral surface thereof in order to generate hydrodynamic pressure at the time of the rotational driving of the shaft 120. In addition, the upper and lower radial dynamic pressure generating grooves may be disposed to be spaced apart from each other by a predetermined interval and have a herringbone or spiral shape.

Further, the sleeve 130 and the housing 140 to be described below may include a first circulation hole 136 formed therebetween in order to connect upper and lower portions of the sleeve 130 to each other. The first circulation hole 136 may be provided as a communication groove formed in at least one of an outer peripheral surface of the sleeve 130 and an inner peripheral surface of the housing 140.

In the case in which the first circulation hole 136 is formed along the outer peripheral surface of the sleeve 130 and has a groove shape in which it allows the upper and lower portions of the sleeve 130 to communicate with each other, the first circulation hole 136 may include a groove formed in a horizontal direction (the radial direction based on FIG. 1) in a bottom surface of the sleeve 130 and a groove formed in a vertical direction (the axial direction based on FIG. 1) in a side of the sleeve 130 in a state in which it is in communication with the groove formed in the bottom surface of the sleeve 130. In addition, the groove may be formed in the horizontal direction (the radial direction based on FIG. 1) in the bottom surface of the sleeve 130, and the groove may be formed in the side of the sleeve 130 by cutting a portion of the side of the sleeve 130 in the vertical direction (the axial direction based on FIG. 1) in a state in which it is in communication with the groove formed in the bottom surface of the sleeve 130. Since the outer peripheral surface of the sleeve 130 and the inner peripheral surface of the housing 140 have a circular shape, when the outer peripheral surface of the sleeve 130 is cut vertically (in the axial direction based on FIG. 1), a space between the sleeve 130 and the housing 140 is naturally formed, such that the first circulation hole 136 may be provided.

Further, in the case in which a circulation hole is formed along the inner peripheral surface of the housing 140, the circulation hole may be formed in the same method as that of forming the circulation hole in the outer peripheral surface of the sleeve 130. However, the case in which the circulation hole is formed along the inner peripheral surface of the housing 140 is slightly different from the case in which the circulation hole is formed in the outer peripheral surface of the sleeve 130, in that a groove in communication with the circulation groove formed in the inner peripheral surface of the housing 140 may be formed along an upper surface of the cover member 170 since a lower surface of the sleeve 130 may partially contact the cover member 170.

The housing 140 may be coupled to the outer peripheral surface of the sleeve 130 while enclosing the sleeve 130. More specifically, the sleeve 130 may be inserted into the inner peripheral surface of the housing 140 and be coupled thereto by press-fitting or bonding.

The housing 140 may be coupled to the outer peripheral surface of the sleeve 130 containing oil to thereby prevent the oil from being leaked.

In addition, an inner surface of a portion of the housing 140 in which the flange part 145 is provided may be spaced apart from the sleeve 130 by a predetermined interval to form an annular space 141. The space 141 may be provided by allowing the inner peripheral surface of the housing 140 or the outer peripheral surface of the sleeve 130 to be stepped.

The housing 140 may include the flange part 145 extended to be disposed over the stopper member 160. In addition, the flange part 145 may serve to limit excessive floating of the rotor hub 150.

Further, the housing 140 may include a second circulation hole 146 connecting the first circulation hole 136 provided in the sleeve 130 to a space formed by the stopper member 160 and the outer peripheral surface of the housing 140.

More specifically, the housing 140 may include the second circulation hole 146 formed under the flange part 145 and connected to the first circulation hole 136.

In addition, the first circulation hole 136 may be formed along the outer peripheral surface of the sleeve 130 or the inner peripheral surface of the housing 140 to thereby be connected to the second circulation hold 146. That is, the first circulation hole 136 may be connected to the space formed by the stopper member 160 and the outer peripheral surface of the housing 140 by the second circulation hole 146 while connecting the bearing clearance C1 formed by the shaft 120 and the cover member 170 and the bearing clearance C1 formed by the sleeve 130 and the rotor hub 150 to each other. Therefore, the first and second circulation holes 136 and 146 may connect three bearing clearances C1 to each other.

The rotor hub 150, which is a rotating member forming the rotor 40 together with the shaft 120, may be coupled to the upper end portion of the shaft 120 and include an extension wall part 152 extended to be disposed outwardly of the sleeve 130.

Meanwhile, the rotor hub 150 may include a rotor hub body 154 provided with an mounting hole 154a into which the upper end portion of the shaft 120 is inserted, a magnet mounting part 156 extended downwardly from an edge of the rotor hub body 154 in the axial direction, and a disk seat part 158 extended from a distal end of the magnet mounting part 156 in the outer radial direction.

In addition, the magnet mounting part 156 may have a driving magnet 156a installed on an inner surface thereof, wherein the driving magnet 156a is disposed to face a front end of the stator core 104 having the coil 102 wound therearound.

Meanwhile, the driving magnet 156a may have an annular ring shape and be a permanent magnet generating magnetic force having a predetermined strength by alternately magnetizing an N pole and an S pole in a circumferential direction.

Here, rotational driving of the rotor hub 150 will be briefly described. When power is supplied to the coil 102 wound around the stator core 104, driving force capable of rotating the rotor hub 150 is generated by electromagnetic interaction between the driving magnet 156a and the stator core 104 having the coil 102 wound therearound.

Therefore, the rotor hub 150 may be rotated. In addition, the shaft 120 on which the rotor hub 150 is fixedly installed may be rotated together with the rotor hub 150 by the rotation of the rotor hub 150.

In addition, the extension wall part 152 may be extended downwardly from a lower surface of the rotor hub body 154 in the axial direction and be stepped such that the stopper member 160 may be installed thereto.

Meanwhile, the rotor hub 150 may be integrally provided with the shaft 120.

The stopper member 160 may be fixed to the extension wall part 152 of the rotor hub 152 and form, together with the outer peripheral surface of the housing 140, a space in which a liquid-vapor interface is formed.

In addition, an inner peripheral surface of the stopper member 160 and the outer peripheral surface of the housing 140 disposed to face the inner peripheral surface of the stopper member 160 may be inclined so that an interface between the lubricating fluid and air may be formed.

Further, in the case in which the stopper member 160 is installed on the extension wall part 152, the flange part 145 of the housing 140 may be disposed over the stopper member 160 so as to face the stopper member 160. Therefore, when an external impact is applied thereto, the stopper member 160 is supported by the extension wall part 152, whereby excessive floating of the rotor hub 150 and the shaft 120 may be suppressed.

In addition, a second thrust dynamic pressure generating groove 162 for generating thrust hydrodynamic pressure may be formed in at least one of an upper surface of the stopper member 160 and a lower surface of the flange part 145.

Therefore, the second thrust dynamic pressure generating groove 162 generates thrust hydrodynamic pressure at the time of the rotation of the shaft 120, whereby the rotation of the rotor hub 150 may be more stably supported.

In addition, the lubricating fluid may move along the flange part 145 and the first and second circulation holes 136 and 146 by the second thrust dynamic pressure generating groove 162.

The housing 140 may include a mounting groove 148 formed in a lower end portion thereof so that the cover member 170 may be installed therein.

The cover member 170, which is a fixed member forming the stator 20 together with the base member 110, the sleeve 130, and the housing 140, may be installed on the lower end portion of the housing 140 to thereby serve to prevent the lubricating fluid filling the bearing clearance C1 from being leaked to the lower end portion of the housing 140.

Meanwhile, the cover member 170 may be bonded to the mounting groove 148 of the housing 140 by an adhesive and/or welding.

Meanwhile, the cover member 170 may be integrally provided with the housing 140.

Here, a movement path of the lubricating fluid will be described.

First, as shown in FIG. 3, at the time of the rotational driving of the shaft 120, a first circulation S1 in which the lubricating fluid moves from a lower portion of the first circulation hole 136 toward an upper portion thereof and a second circulation S2 in which the lubricating fluid moves from the first circulation hole 136 toward the bearing clearance C1 formed by the flange part 145 and the stopper member 160, that is, the second circulation hole 146 may be formed.

That is, a movement path of the first circulation S1 is as follows.

First, the lubricating fluid moves from the upper radial dynamic pressure generating groove 123 to the lower radial dynamic pressure generating groove 124, moves from the lower portion of the first circulation hole 136 toward the upper portion thereof, and then moves in the inner radial direction in the bearing clearance C1 formed by the rotor hub 150 and the upper surface of the sleeve 130.

In addition, a movement path of the second circulation S2 is as follows. The lubricating fluid moves from the second thrust dynamic pressure generating groove 162 to the bearing clearance C1 formed by the flange part 145 and the extension wall part 152 by the second thrust dynamic pressure generating groove 162, moves in the inner radial direction in the bearing clearance C1 formed by the rotor hub 150 and the upper surface of the housing 140, and then moves from the upper portion of the first circulation hole 136 to the second circulation hole 146.

As described above, since the second circulation S2 is formed, generation of negative pressure and an abnormal increase in pressure may be suppressed. That is, the second circulation S2 is formed in an area having a possibility that pressure may become unstable, whereby the generation of the negative pressure and the abnormal increase in pressure may be reduced.

In addition, air bubbles generated at the time of the rotational driving of the shaft 120 may be more easily discharged to the outside by the second circulation S2. That is, the air bubbles moving from the lower portion of the first circulation hole 136 to the upper portion thereof may move to a space in which the liquid-vapor interface is formed, by the second circulation S2 through the second circulation hole 146.

Therefore, the air bubbles may be easily discharged.

As described above, the stopper member 160 is installed on the extension wall part 152, such that a bearing span length is increased, whereby rotational characteristics may be improved and power consumption may be reduced.

Here, the bearing span length indicates a distance between a region in which maximum dynamic pressure is generated while the lubricating fluid is pumped by the upper radial dynamic pressure generating groove 123 and a region in which maximum dynamic pressure is generated while the lubricating fluid is pumped by the lower radial dynamic pressure generating groove 124.

That is, the stopper member 160 is installed on the extension wall part 152, such that a distance between the upper and lower radial dynamic pressure generating grooves 123 and 124 is increased, whereby the bearing span length may be increased.

Therefore, the rotational characteristics may be improved and the power consumption may be reduced.

In addition, since force pulling the rotor hub 150 toward the base member 110 by magnetic force is not required through the first and second thrust dynamic pressure generating grooves 122 and 162, in other words, a double thrust structure, a pulling plate need not to be installed, whereby manufacturing costs may be reduced.

Further, since the force pulling the rotor hub 150 toward the base member 110, that is, pulling force is not required, loss of power for generating the puling force is reduced, whereby the power consumption may be reduced.

In addition, since the upper and lower portions of the sleeve 130 and the outer peripheral surface of the housing 140 may be connected to each other through the first and second circulation holes 136 and 146, the generation of the negative pressure and the abnormal increase in pressure may be prevented.

Further, the air bubbles may be easily discharged through the first and second circulation holes 136 and 146.

Hereinafter, a spindle motor according to another embodiment of the present invention will be described with reference to the accompanying drawings. However, a detailed description of the same components as the above-mentioned components will be omitted and be replaced by the above-mentioned description.

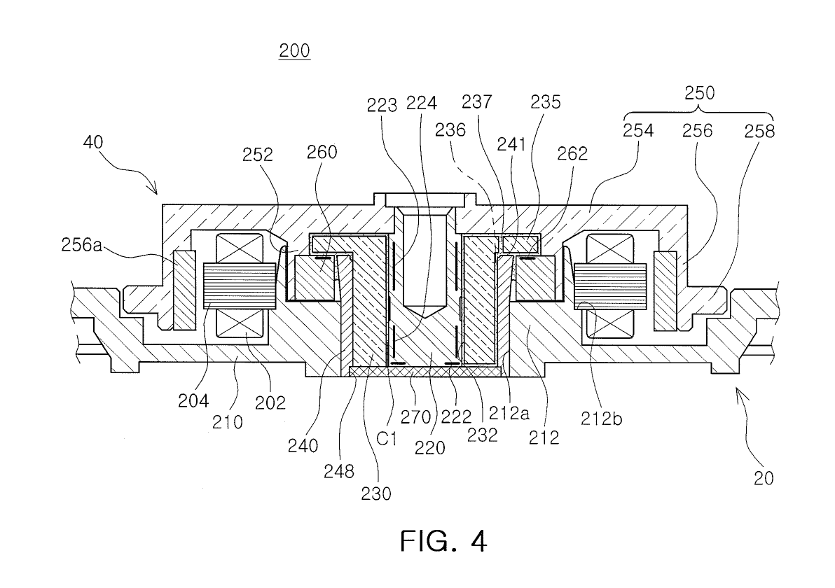

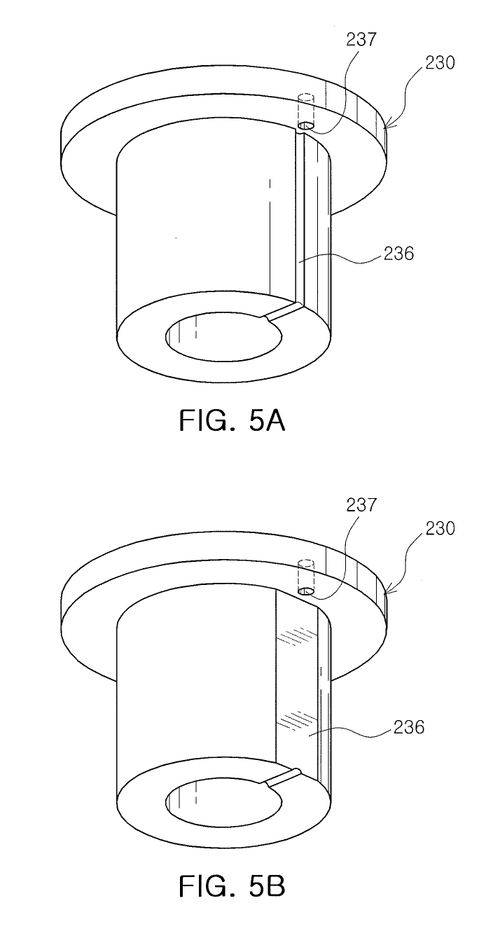

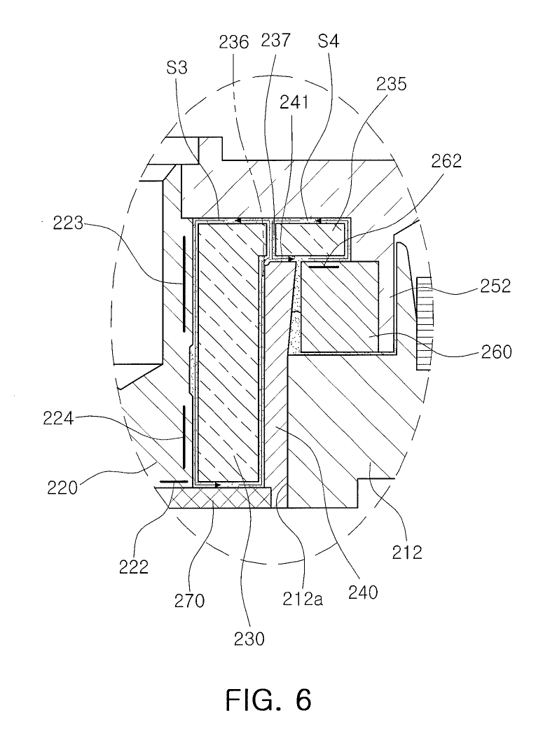

FIG. 4 is a cross-sectional view schematically showing a spindle motor according to another embodiment of the present invention; FIGS. 5A and 5B are perspective views showing a sleeve according to another embodiment of the present invention; and FIG. 6 is a view describing an operation of the spindle motor according another embodiment of the present invention.

Referring to FIGS. 4 through 6, a spindle motor 200 according to another embodiment of the present invention may include a base member 210, a shaft 220, a sleeve 230, a housing 240, a rotor hub 250, a stopper member 260, and a cover member 270.

Meanwhile, the base member 210, the shaft 220, the rotor hub 250, the stopper member 260, and the cover member 270 provided in the spindle motor 200 according to this embodiment of the present invention are substantially identical to the base member 110, the shaft 120, the rotor hub 150, the stopper member 160, and the cover member 170 provided in the spindle motor 100 according to the foregoing embodiment of the present invention. Therefore, a detailed description thereof will be omitted and be replaced by the above-mentioned description.

The sleeve 230 may form a bearing clearance C1 filled with a lubricating fluid.

Meanwhile, the sleeve 230 may be inserted into an installation part 212 of the base member 210 in a state in which it is fixed in the housing 240, such that it may be fixed to the base member 210. That is, an outer peripheral surface of the housing 240 may be adhered to an inner peripheral surface of the installation part 212 by an adhesive.

Further, the sleeve 230 may include a shaft hole 232 formed therein, such that the shaft 220 is inserted thereinto. Further, in the case in which the shaft 220 is insertedly disposed in the shaft hole 232 of the sleeve 230, an inner peripheral surface of the sleeve 230 and the outer peripheral surface of the shaft 220 may be spaced apart from each other by a predetermined interval to thereby form the bearing clearance C1 therebetween.

In addition, the sleeve 230 may include a flange part 235 formed in an upper end portion thereof to be extended outwardly. Further, the housing 240 may be provided to enclose an outer peripheral surface of the sleeve 230 while an upper end surface thereof may be disposed to be spaced apart from a lower surface of the flange part 235 of the sleeve 230 by a predetermined interval. That is, the housing 240 may be provided to enclose the outer peripheral surface of the sleeve 230 except for the flange part 235 of the sleeve 230 and a portion under the flange part 235. Therefore, the upper end portion of the housing 240 and the lower surface of the flange part 235 may be spaced apart from each other by a predetermined interval to thereby form a space 241.

Here, the bearing clearance C1 will be described in more detail. As described above, the sleeve 230 forms the bearing clearance C1 filled with the lubricating fluid. This bearing clearance C1 indicates a clearance formed by the shaft 220 and the sleeve 230, a clearance formed by an upper end portion of the sleeve 230 and the rotor hub 250, a clearance formed by the sleeve 230 and the stopper member 260, a clearance formed by the cover member 270 and the sleeve 230, a clearance formed by the housing 240 and the sleeve 230 or the stopper member 260, and a clearance formed by the cover member 270 and the lower surface of the shaft 220.

In addition, the spindle motor 200 according to the present embodiment may have a structure in which the entire bearing clearance C1 is filled with the lubricating fluid. This structure may be called a full-fill structure.

Meanwhile, the shaft 220 may include upper and lower radial dynamic pressure generating grooves 223 and 224 formed in the outer peripheral surface thereof in order to generate hydrodynamic pressure at the time of rotational driving thereof. In addition, the upper and lower radial dynamic pressure generating grooves 223 and 224 may be spaced apart from each other by a predetermined interval and have a herringbone or spiral shape.

In addition, at the time of the rotational driving of the shaft 220, the lubricating fluid may move from the upper radial dynamic pressure generating groove 223 toward the lower radial dynamic pressure generating groove 224. That is, the spindle motor 200 according to the present embodiment may have a down pumping structure.

Meanwhile, the sleeve 230 may include the flange part 235 extended so as to be disposed over the stopper member 260. In addition, the flange part 235 may serve to limit excessive floating of the rotor hub 250 and the shaft 220.

Further, the sleeve 230 and the housing 240 may include a third circulation hole 236 formed therebetween in order to connect a lower portion of the sleeve 230 and an upper end surface of the housing 240 to each other and a fourth circulation hole 237 formed therebetween in order to connect the third circulation hole 236 and an upper portion of the sleeve 230 to each other.

In addition, as described above, since the upper end portion of the housing 240 and the lower surface of the flange part 235 are spaced apart from each other by a predetermined interval to thereby form the space 241, the third and fourth circulation holes 236 and 237 may be connected to a space formed by the stopper member 260 and the outer peripheral surface of the sleeve 230 through the space 241.

Therefore, the space 241 and the third and fourth circulation holes 236 and 237 may connect three bearing clearances C1 to each other.

Here, a movement path of the lubricating fluid will be described.

First, at the time of the rotational driving of the shaft 220, a third circulation S3 in which the lubricating fluid moves from lower portions of the third and fourth circulation holes 236 and 237 toward upper portions thereof and a fourth circulation S4 in which the lubricating fluid moves from the third and fourth circulation holes 236 and 237 toward the bearing clearance C1 formed by the flange part 235 and the stopper member 260 may be formed.

That is, a movement path of the third circulation S3 is as follows.

First, the lubricating fluid moves from the upper radial dynamic pressure generating groove 223 to the lower radial dynamic pressure generating groove 224, moves from the lower portion of the sleeve 230 toward the upper portion thereof by the third and fourth circulation holes 236 and 237, and then moves in the inner radial direction in the bearing clearance C1 formed by the rotor hub 250 and the upper surface of the sleeve 230.

In addition, a movement path of the fourth circulation S4 is as follows. The lubricating fluid moves from the second thrust dynamic pressure generating groove 262 to the bearing clearance C1 formed by the flange part 235 and the extension wall part 252 by the second thrust dynamic pressure generating groove 262, moves in the inner radial direction in the bearing clearance C1 formed by the rotor hub 250 and the upper surface of the sleeve 230, and then moves from the upper portion of the fourth circulation hole 237 to the space 241.

As described above, since the fourth circulation S4 is formed, generation of negative pressure may be suppressed. That is, the fourth circulation S4 is formed in a region in which the negative pressure is generated, whereby the generation of the negative pressure may be reduced.

In addition, air bubbles generated at the time of the rotational driving of the shaft 220 may be more easily discharged to the outside by the fourth circulation S4. That is, air bubbles moving from the lower portion of the third circulation hole 236 to the upper portion thereof may move to a space in which a liquid-vapor interface is formed through the spaced space 241.

Therefore, the air bubbles may be easily discharged.

As described above, the stopper member 260 is installed on the extension wall part 252, such that a bearing span length is increased, whereby rotational characteristics may be improved and power consumption may be reduced.

Here, the bearing span length indicates a distance between a region in which maximum dynamic pressure is generated while the lubricating fluid is pumped by the upper radial dynamic pressure generating groove 223 and a region in which maximum dynamic pressure is generated while the lubricating fluid is pumped by the lower dynamic pressure generating groove 224.

That is, the stopper member 260 is installed on the extension wall part 252, such that a distance between the upper and lower radial dynamic pressure generating grooves 223 and 224 is increased, whereby the bearing span length may be increased.

Therefore, the rotational characteristics may be improved and the power consumption may be reduced.

In addition, since force pulling the rotor hub 250 toward the base member 210 by magnetic force is not required through the first and second thrust dynamic pressure generating grooves 222 and 262, that is, a double thrust structure, the pulling plate need not to be installed, whereby manufacturing costs may be reduced.

Further, since the force pulling the rotor hub 250 toward the base member 210, that is, pulling force is not required, loss of power for generating the puling force is reduced, whereby the power consumption may be reduced.

In addition, since the upper and lower portions of the sleeve 230 and the outer peripheral surface of the sleeve 230 may be connected to each other through the third and fourth circulation holes 236 and 237 and the space 241, the generation of the negative pressure and the abnormal increase in pressure may be prevented.

Further, the air bubbles may be easily discharged through the third and fourth circulation holes 236 and 237 and the space 241 as described above.

As set forth above, according to the embodiments of the present invention, the generation of the negative pressure and the excessive floating of the rotor maybe reduced through the circulation hole connecting to the upper and lower portions of the sleeve to each other and connected to the spaced formed by the stopper member and the outer peripheral surface of the sleeve.

That is, since the circulation hole is connected to the space formed by the stopper member and the outer peripheral surface of the sleeve, pressure in the upper and lower portions of the sleeve connected to each other by the circulation hole may be controlled by atmospheric pressure. Therefore, the generation of the negative pressure may be reduced, and the excessive floating of the rotor due to the abnormal increase in pressure may be prevented.

In addition, the air bubbles generated during the rotational driving of the shaft may be easily discharged by the second circulation.

Further, the stopper member may not be installed on the shaft, such that the bearing span length may be increased, whereby the rotational characteristics may be improved and the power consumption may be reduced.

Furthermore, the power consumption may be further reduced through the first and second thrust dynamic pressure bearings.

While the present invention has been shown and described in connection with the embodiments, it will be apparent to those skilled in the art that modifications and variations can be made without departing from the spirit and scope of the invention as defined by the appended claims.

What is claimed is:

1. A hydrodynamic bearing assembly comprising:
a sleeve supporting a shaft such that an upper end portion of the shaft is protruded upwardly in an axial direction, and forming a bearing clearance filled with a lubricating fluid;
a housing provided to enclose an outer peripheral surface of the sleeve and including a flange part formed in an upper end portion thereof and extended outwardly;
a rotor hub coupled to the upper end portion of the shaft and including an extension wall part extended to be disposed outwardly of the housing;
a stopper member fixed to the extension wall part of the rotor hub while being disposed under the flange part of the housing, and forming, together with an outer peripheral surface of the housing, a space in which a liquid-vapor interface is formed; and
a cover member coupled to a lower end portion of the housing,
wherein the sleeve and the housing include a first circulation hole formed therebetween in order to connect upper and lower portions of the sleeve to each other, and a second circulation hole formed therebetween in order to connect the first circulation hole and a space formed by the stopper member and the outer peripheral surface of the housing to each other.

2. The hydrodynamic bearing assembly of claim 1, wherein the sleeve and an inner surface of a portion of the housing in which the flange part is provided form an annular space therebetween.

3. The hydrodynamic bearing assembly of claim 1, wherein a first thrust dynamic pressure generating groove for generating thrust hydrodynamic pressure is formed in at least one of a lower surface of the shaft and an upper surface of the cover member.

4. The hydrodynamic bearing assembly of claim 1, wherein a second thrust dynamic pressure generating groove for generating thrust hydrodynamic pressure is formed in at least one of a lower surface of the flange part and an upper surface of the stopper member.

5. The hydrodynamic bearing assembly of claim 1, wherein, at the time of rotational driving of the shaft, a first circulation in which the lubricating fluid moves from a lower portion of the first circulation hole toward an upper portion thereof and a second circulation in which the lubricating fluid moves from the first circulation hole toward a bearing clearance formed by the flange part and the stopper member are formed.

6. The hydrodynamic bearing assembly of claim 1, wherein the shaft includes upper and lower radial dynamic pressure generating grooves formed in an outer peripheral surface thereof in order to generate hydrodynamic pressure at the time of rotational driving thereof, and
the lubricating fluid moves from the upper radial dynamic pressure generating groove toward the lower radial dynamic pressure generating groove.

7. The hydrodynamic bearing assembly of claim 1, wherein the housing is integrally provided with the cover member.

8. The hydrodynamic bearing assembly of claim 1, wherein the shaft is integrally provided with the rotor hub.

9. The hydrodynamic bearing assembly of claim 1, wherein the first circulation hole is provided as a communication groove formed in at least one of the outer peripheral surface of the sleeve and an inner peripheral surface of the housing.

10. A hydrodynamic bearing assembly comprising:
a sleeve supporting a shaft such that an upper end portion of the shaft is protruded upwardly in an axial direction, forming a bearing clearance filled with a lubricating fluid, and including a flange part formed in an upper end portion thereof and extended outwardly;
a housing provided to enclose an outer peripheral surface of the sleeve while allowing an upper end surface thereof to be spaced apart from a lower surface of the flange part of the sleeve by a predetermined interval;
a rotor hub coupled to the upper end portion of the shaft and including an extension wall part extended to be disposed outwardly of the sleeve and the housing;
a stopper member fixed to the extension wall part of the rotor hub while being disposed under the flange part of the sleeve and forming, together with an outer peripheral surface of the housing, a space in which a liquid-vapor interface is formed; and
a cover member coupled to a lower end portion of the housing,
wherein the sleeve and the housing includes a third circulation hole formed therebetween in order to connect a lower portion of the sleeve and the upper end surface of the housing to each other and a fourth circulation hole formed therebetween in order to connect the third circulation hole and an upper portion of the sleeve to each other.

11. The hydrodynamic bearing assembly of claim 10, wherein a third thrust dynamic pressure generating groove for generating thrust hydrodynamic pressure is formed in at least one of a lower surface of the shaft and an upper surface of the cover member.

12. The hydrodynamic bearing assembly of claim 10, wherein a fourth thrust dynamic pressure generating groove for generating thrust hydrodynamic pressure is formed in at least one of a lower surface of the flange part and an upper surface of the stopper member.

13. The hydrodynamic bearing assembly of claim 10, wherein, at the time of rotational driving of the shaft, a third circulation in which the lubricating fluid moves from lower portions of the third and fourth circulation holes toward upper portions thereof and a fourth circulation in which the lubricating fluid moves from the third circulation hole toward a bearing clearance formed by the flange part and the stopper member are formed.

14. The hydrodynamic bearing assembly of claim 10, wherein the shaft includes upper and lower radial dynamic pressure generating grooves formed in an outer peripheral surface thereof in order to generate hydrodynamic pressure at the time of rotational driving thereof, and
the lubricating fluid moves from the upper radial dynamic pressure generating groove toward the lower radial dynamic pressure generating groove.

15. The hydrodynamic bearing assembly of claim 10, wherein the third circulation hole is provided as a communication groove formed in at least one of the outer peripheral surface of the sleeve and an inner peripheral surface of the housing.

16. The hydrodynamic bearing assembly of claim 10, wherein the fourth circulation hole penetrates through the flange part so as to connect the third circulation hole and the upper portion of the sleeve to each other.

17. A spindle motor comprising:
the hydrodynamic bearing assembly of claim 1; and
a stator coupled to an outside of the housing and including a core having a coil wound therearound in order to generate rotational driving force.
